(19) United States
(12) Patent Application Publication
(10) Pub. No.: US 2006/0085329 A1
(43) Pub. Date: Apr. 20, 2006

(54) Storage accounting system, method of storage accounting system, and signal-bearing medium embodying program for performing storage system

(75) Inventor: Norihiro Eguchi, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Corporation, Tokyo (JP)

(21) Appl. No.: 11/248,171

(22) Filed: Oct. 13, 2005

(30) Foreign Application Priority Data
Oct. 14, 2004 (JP) 2004-300816

(51) Int. Cl. G06Q 40/00

(52) U.S. Cl. 705/39; 709/203

(57) ABSTRACT

A storage accounting system which includes a host computer, and a storage service apparatus that stores data requested by the host computer in accordance with a data access rate of a service agreement. The storage service apparatus monitors a data access rate of the host computer and selectively adjusts a parameter of the service agreement based on the monitoring.

### BACKGROUND OF THE INVENTION

The present invention relates to a storage accounting system, a method of storage accounting, and a signal-bearing medium embodying a program for performing storage respectively related to the utilization of a data storage and others in which data can be stored via a network. The present invention particularly relates to a storage accounting, a method of storage accounting system, and a signal-bearing medium embodying a program for performing a storage service based upon an access rate to a data storage.

In a computer system operated and managed by a company, the operation and the management of storage becomes complex and the cost increases because of increased quantity of data in a storage device (hereinafter called the “storage”). As a result, the operation and the management of the storage for carrying out them for the computer system of the company are typically left in charge of a storage service provider (hereinafter called “SSP”).

An SSP is provided typically with plural storages, divides them, and lends them out to plural users. The user pays a charge for using the storage and the SSP operates and manages the storage. The user who leaves data in the SSP can reduce a cost for operating and managing data by adopting such a mode.

In a patent document 1 (JP-A No. 162591/2003), a communication service quality assurance method and system are disclosed in which a user can receive quality assurance according to actually received service quality by providing a quality monitor to each terminal of the user. Further with the method and the system, reliability based upon the result of the judgment of the user can be enhanced by judging whether a quality assurance contract is broken or not in a management server of a management service provider. The management service provider is a third party different from a service provider.

In a patent document 2 (JP-A No. 244899/2002), a storage system is provided with a data access rate assurance which is configured by arithmetic resources, a storage system and a communication link for connecting the arithmetic resources and the storage system. The arithmetic resources establish communication with the storage system using the communication link. Further, the storage system allocates resources to the arithmetic resources based upon the data transfer capability of storage resources and the data transfer capability of the communication link.

In a patent document 3 (JP-A No. 203126/2003), a storage device operation system and a storage device rental service method prepare a second best setting plan that partially meets a setting request of a user, even if the first setting request of the user is not met. The storage setting plan that is prepared based upon the storage setting request by the user who rents a storage can meet the storage setting request of the user, by changing a storage condition with another user, by presenting a condition such as discounting the price of the storage to another user and negotiating with him/her on the condition.

In a patent document 4 (JP-A No. 236852/2002), an accounting method is disclosed in which not only fixed accounting according to storage capacity is done, but accounting is performed according to a frequency of access and data transfer quantity in units of a connecting server, the frequency of access and data transfer quantity in units of a world wide name (WWN), the frequency of access and data transfer quantity in units of a channel port, the frequency of access and data transfer quantity in units of a storage device, and the frequency of access and data transfer quantity in units of an area in the storage device.

In a patent document 5 (JP-A No. 281293/2003), a data storage service is proposed in which precise accounting is performed based upon an actual situation of the utilization of storage by a user. In such a data storage service, a data storage quantity that varies continuously in the storage is converted into an intermediate unit such as a block and a pixel. Then, the data storage quantity is monitored and recorded at shorter, regular time intervals. The increase/decrease of data quantity is reflected and the storage quantity of the corresponding data is in units of a file.

### SUMMARY OF THE INVENTION

However, prior to the invention, when a data access rate of a service agreement cannot be assured, storage service apparatus cannot selectively adjust a parameter of the service agreement without linkage with an Internet Service Provider (ISP), so that storage service apparatus may compensate the user. For example, the above-mentioned conventional methods and systems have the following problems.

As the communication service quality assurance method and system respectively disclosed in the patent document 1 assure the quality of service which a user actually receives by providing a quality monitor to each terminal of the user, a database controller cannot uniquely assure a data access rate. Specifically, when a quality monitor is provided to each user terminal, the database controller is required to assure the quality of service in linkage with an ISP.

The storage system disclosed in the patent document 2 assures the data access rate that meets a request for arithmetic resources by allocating resources to the arithmetic resources based upon the data transfer capability and of the storage resources and the data transfer capability of the communication link. However, accounting according to the data access rate is disabled.

The storage device operation system and the storage device rental service method respectively disclosed in the patent document 3 meet a storage setting request by a user by preparing a storage performance price table, presenting a condition such as discounting the price of the storage to the user and negotiating with the user on the condition so as to meet the setting request by the user. However, if a data access rate cannot be assured, then the storage setting request of the user cannot be compensated.

The storage accounting system disclosed in the patent document 4, and the data storage meter rate accounting method and the data storage meter rate accounting device respectively disclosed in the patent document 5 perform accounting according to an actual situation of the utilization of a user based upon the capacity of a storage allocated to the user, actually used capacity, a data access frequency and data transfer quantity. However, accounting based upon a data access rate is not performed. Thus, it not only takes a long time for a remote user to access data, it also is difficult to guarantee data access to the remote user.

In view of the foregoing and other exemplary problems, drawbacks, and disadvantages of the conventional techniques, it is an exemplary feature of the present invention to provide a storage accounting system, a storage service apparatus, a host computer, a method of storage accounting, a method of storage service, a method of a host computer, a signal-bearing medium embodying a program for performing a method of storage service, and a signal-bearing medium embodying a program for performing a method of the host computer.

In an exemplary feature of the present invention, storage can be efficiently utilized by assuring a data access rate which a user minimally requires and changing the setting of a charge according to a request from the user and a provided data access rate.

The present invention provides a storage accounting system. The storage accounting system may include a host computer, and a storage service apparatus that stores data requested by the host computer in accordance with a data access rate of a service agreement. The storage service apparatus monitors a data access rate of the host computer, and selectively adjusts a parameter of the service agreement based on the monitoring.

When a monitored data access rate of the host computer is slower than the data access rate of the service agreement, the storage service apparatus may compute a lesser charge for the host computer.

The storage service apparatus may store a penalty frequency when the monitored data access rate of the host computer is slower than the data access rate of the service agreement, and the storage service apparatus may compute the lesser charge based upon the penalty frequency.

The slower the data access rate of the host computer is, the less charge the storage service apparatus may compute for the host computer.

The storage accounting system may further include an accounting server that includes a memory that stores the data access rate of the service agreement and the penalty frequency, the accounting server comparing the data access rate of the host computer, and the data access rate of the service agreement.

The accounting server may update the penalty frequency when the monitored data access rate of the host computer is slower than the data access rate of the service agreement.

The accounting server may send the charge to the host computer.

The storage accounting system may further include a storage having a physical disk that stores data requested by the host computer, a storage controller connected to the host computer, a plurality of channel ports for input and output, an I/O process controller that monitors the data access rate of the host computer, a data access rate memory connected to the storage controller that stores the data access rate in the transfer of the data to the host computer, and an accounting server controller that controls an operation of the accounting server. The host computer may request the storage to transfer the data and the storage controller transfers the data from the physical disk to the host computer when the transfer of the data is requested by the host computer, and the storage controller may store the data access rate in the transfer of the data in the data access rate memory when the transfer of the data from the physical disk is completed, the storage controller may transmit the data access rate to the accounting server when the data access rate is stored in the data access rate memory, the accounting server controller may compare the data access rate and the data access rate of the service agreement stored in the memory when the accounting server receives the data access rate, the accounting server controller may update the penalty frequency when the data access rate is slower than the data access rate of the service agreement, the accounting server controller may compute the charge based upon the penalty frequency and the accounting server controller sends the charge to the host computer.

In accordance with the present invention, the storage accounting system may include means for using data, and means for storing data requested by the data using means in accordance with a data access rate of a service agreement, the means for storing data monitoring a data access rate of the data using means, and selectively adjusting a parameter of the service agreement based on the monitoring.

The present invention also provides a storage service apparatus. The storage service may include a storage that stores data requested by a host computer in accordance with a data access rate of a service agreement, an input/output (I/O) process controller that monitors a data access rate of the host computer, and an accounting server that selectively adjusts a parameter of the service agreement based on the monitoring.

The storage service may include means for storing data requested by a host computer in accordance with a data access rate of a service agreement, means for monitoring a data access rate of the host computer, and means for selectively adjusting a parameter of the service agreement based on the monitoring.

The present invention also provides a host computer. The host computer may include a controller that uses a storage in a storage service apparatus, a receiver that receives a charge of a service agreement. The charge is selectively adjusted by the storage service apparatus.

The host computer may include means for using storage in a storage service apparatus, means for receiving a charge of a service agreement. The charge is selectively adjusted by the storage service apparatus.

The present invention also provides a method of storage accounting. The method includes storing data requested by a host computer in accordance with a data access rate of a service agreement, monitoring a data access rate of the host computer, and selectively adjusting a parameter of the service agreement based on the monitoring.

The method may further include computing a lesser charge for the host computer, when the data access rate of the host computer is slower than the data access rate of the service agreement.

The method may further include storing a penalty frequency at which the data access rate of the host computer is slower than the data access rate of the service agreement, and computing the lesser charge based upon the penalty frequency.

In accordance with the method, the slower the data access rate of the host computer, the less charge may be computed for the host computer.

The method may include comparing the data access rate of the host computer and the data access rate of the service agreement.

The method may include updating the penalty frequency when the monitored data access rate of the host computer is slower than the data access rate of the service agreement.

The method may include sending the charge to the host computer.

The method may include providing a storage having a physical disk that stores data requested by the host computer, connecting storage controller to the host computer, providing a plurality of channel ports for input and output, wherein the monitoring is performed by an I/O process controller, connecting a data access rate memory connected to the storage controller for storing the data access rate in the transfer of the data to the host computer, and controlling by an accounting server controller, an operation of the accounting server. The method may include requesting by the host computer, the storage to transfer the data, transferring by the storage controller the data from the physical disk to the host computer when the transfer of the data is requested by the host computer, storing by the storage controller, the data access rate in the transfer of the data in the data access rate memory when the transfer of the data from the physical disk is completed, transmitting by the storage controller, the data access rate to the accounting server when the data access rate is stored in the data access rate memory, comparing, by the accounting server controller, the data access rate and the data access rate of the service agreement stored in the memory when the accounting server receives the data access rate, updating, by the accounting server controller, the penalty frequency when the data access rate is slower than the data access rate of the service agreement, computing, by the accounting server controller, the charge based upon the penalty frequency, and sending by the accounting server controller, the charge to the host computer.

The present invention also provides a method of providing a storage service. In accordance with the present invention, the method may storing data requested by a host computer in accordance with a data access rate of a service agreement, monitoring a data access rate of the host computer, and selectively adjusting a parameter of the service agreement based on the monitoring.

The present invention also provides a host computer method. In accordance with the present invention, the method may include using a storage in a storage service apparatus, and receiving a charge of a service agreement, the charge being selectively adjusted by the storage service apparatus.

The present invention also provides a signal-bearing medium embodying a program of machine-readable instructions executable by a digital processing apparatus, the program causing a storage service apparatus to perform a method. In accordance with the present invention, the method may include storing data requested by a host computer in accordance with a data access rate of a service agreement, monitoring a data access rate of the host computer, and selectively adjusting a parameter of the service agreement based on the monitoring.

The present invention also provides a signal-bearing medium embodying a program of machine-readable instructions executable by a digital processing apparatus, the program causing a host computer to perform a method. In accordance with the present invention, the method may include using a storage in a storage service apparatus, and receiving a charge of a service agreement, the charge being selectively adjusted by the storage service apparatus based on the monitoring.

According to the present invention, in case a data access rate of a service agreement cannot be assured, for example, a storage service apparatus can selectively adjust a parameter of the service agreement based on the monitoring without linkage with an ISP so that the storage service apparatus may compensate the user.

For example, the invention enables accounting in consideration of a data access rate by setting a charge according to the data access rate which a user requests, holding a penalty for data access in which the rate requested by the user cannot be provided as the accounting data, and computing a charge based upon these accounting data in the storage system configured so that the data access rate requested by the individual user is met.

### BRIEF DESCRIPTION OF THE DRAWINGS

Novel and exemplary features believed characteristic of the invention are set forth in the appended claims. The invention itself, however, as well as other exemplary features and advantages thereof, will be best understood by reference to the detailed description which follows, read in conjunction with the accompanying drawings, wherein:

FIG. 1 is a block diagram showing the configuration of a storage accounting system in an exemplary embodiment of the present invention;

FIG. 2 shows a data access rate table 611 held in a shared memory 602 in this exemplary embodiment;

FIG. 3 shows an accounting information table 211 held in an accounting server 201 in this exemplary embodiment;

FIG. 4 is a flowchart showing the operation of the storage accounting system in this exemplary embodiment; and

FIG. 5 is a flowchart showing another exemplary operation of the storage accounting system according to the present invention.

### DETAILED DESCRIPTION OF THE EXEMPLARY EMBODIMENTS

An exemplary embodiment of the present invention will be described below.

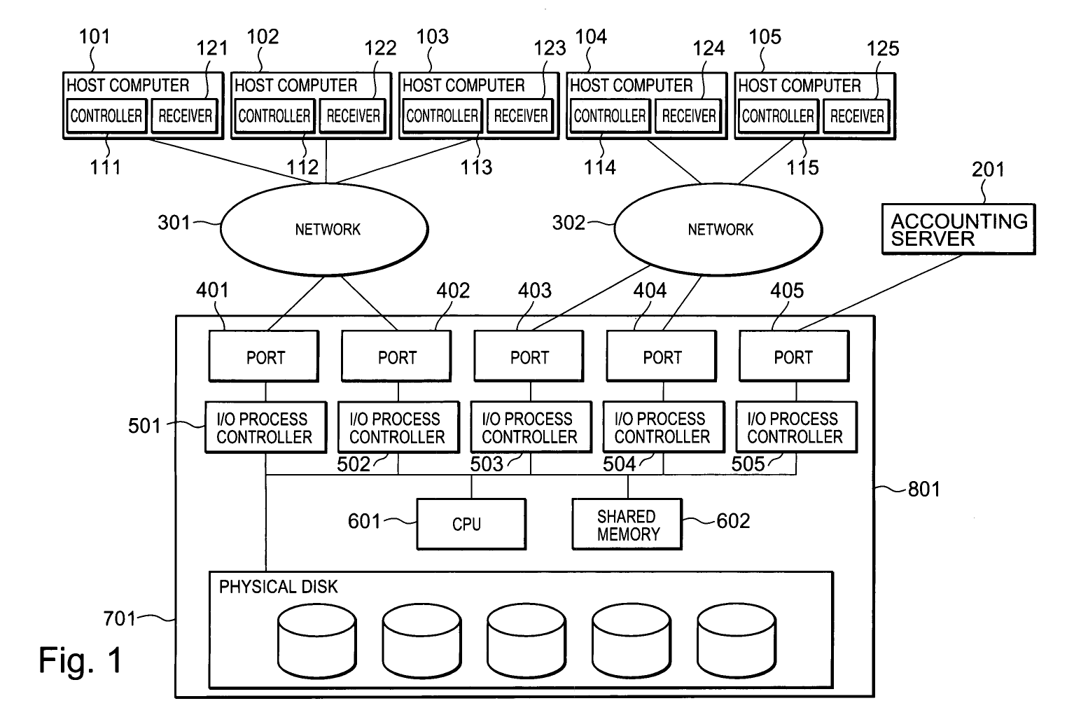

FIG. 1 is a block diagram showing the configuration of a storage accounting system according to the exemplary embodiment.

The storage accounting system of this exemplary embodiment is configured by host computers 101 . . . 105, a storage 801, an accounting server 201 that manages a charge caused when host computer 101 . . . 105 accesses data held in storage 801 and networks 301, 302 for connecting host computer 101 . . . 105 and storage 801. Each host computer 101 . . . 105 is configured with a controller 111 . . . 115 to control each host computer 101 . . . 105 and a receiver 121 . . . 125 to receive a charge from an accounting server described after.

Storage 801 is configured by ports 401 . . . 405 for connecting network 301, 302 and storage 801, I/O process controllers 501 . . . 505 that control an I/O process requested of a physical disk 701, CPU 601 that controls the operation of the entire storage 801, a shared memory 602 accessible from I/O process controller 501 . . . 505 and physical disk 701 that stores data from host computer 101 . . . 105. Storage 801 is configured so that a data access rate requested by each host computer 101 . . . 105 is met. I/O process controllers 501 . . . 505 input/output data to/from physical disk 701.

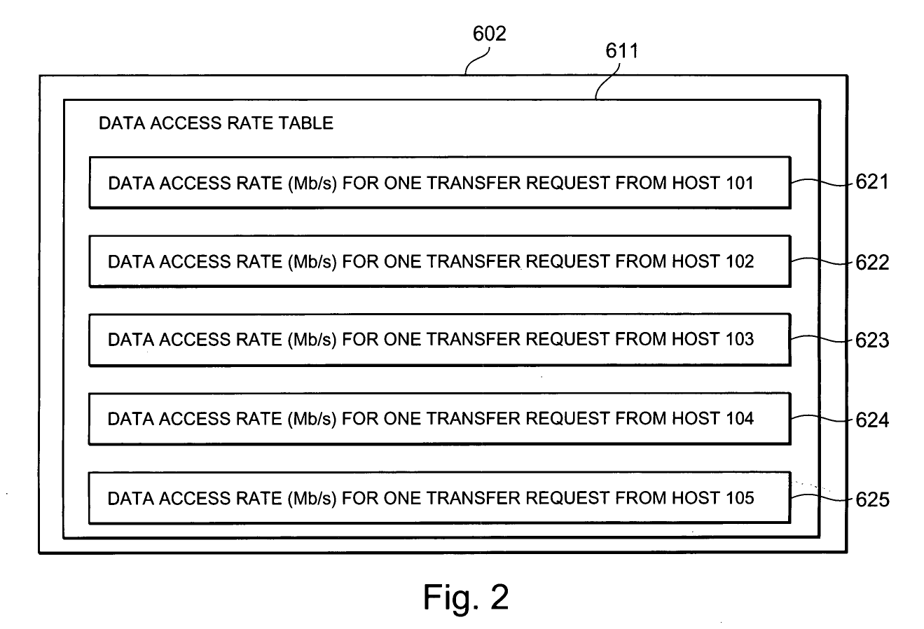

FIG. 2 shows an exemplary data access rate table 611 stored in shared memory 602. Data access rate table 611 holds a data access rate when data is transferred from every host computer to be a target of accounting as a record.

Data access rate table 611 holds a data access rate (Mb/s) 621 for one transfer request from host computer 101, a data access rate (Mb/s) 622 for one transfer request from host computer 102, a data access rate (Mb/s) 623 for one transfer request from host computer 103, a data access rate (Mb/s) 624 for one transfer request from host computer 104, a data access rate (Mb/s) 625 for one transfer request from host computer 105, which are respectively a data access rate for the latest data access of each host computer 101 . . . 105.

I/O process controllers 501 . . . 505 monitor the access rates of each host computer 101 . . . 105. The data access rates held in data access rate table 611 are updated by I/O process controllers 501 . . . 505. Therefore, the storage accounting system can account according to the data access rate. In addition, an SSP operating accounting server 201 can selectively adjust a parameter of the contract without linkage with an ISP, so that SSP may compensate the user for lack of a storage performance or service, etc. When data access rate table 611 is accessed, the latest data access rate of each host computer 101 . . . 105 is transmitted to accounting server 201. The data access rate may represent a value acquired by dividing data transfer quantity in one data access by time, from a data transfer request to the completion of the transfer.

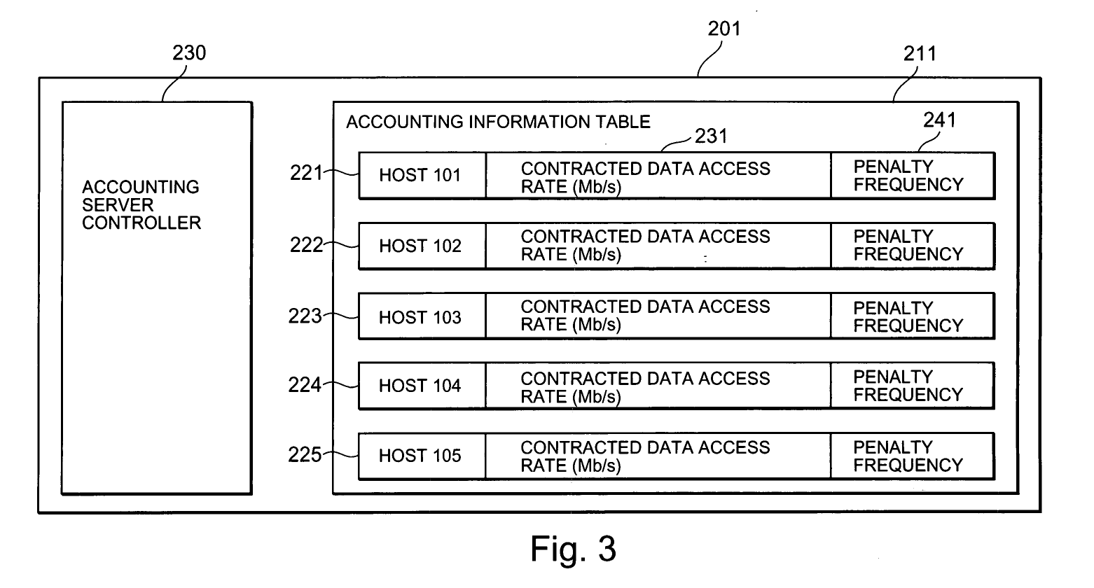

FIG. 3 shows an exemplary accounting information table 211 stored in accounting server 201. Accounting information table 211 stores a data access rate (hereinafter called a “contracted data access rate”) requested by each host computer 101 . . . 105. Table 211 also stores a frequency 241 (hereinafter called a “penalty frequency”) at which the data access rate requested by each host computer 101 . . . 105 cannot be provided every host computer 101 . . . 105 to be a target of accounting. Table 211 is updated by an accounting server controller that controls the operation of the entire accounting server 201. The contracted data access rate is the minimum data access rate requested by each host computer 101 . . . 105, and is set when a user makes a contract for using storage 801.

The accounting server 201 selectively adjusts a parameter (e.g., the penalty frequency 241) of the service agreement (e.g., contract). The penalty frequency may refer to a frequency at which data cannot be provided at the contracted data access rate for data access from each host computer 101 . . . 105. The accounting server controller 230 compares a data access rate of data transmitted from storage 801 and the contracted data access rate, and adds to a penalty frequency 241 held in accounting information table 211 if the data access rate does not meet the contracted data access rate.

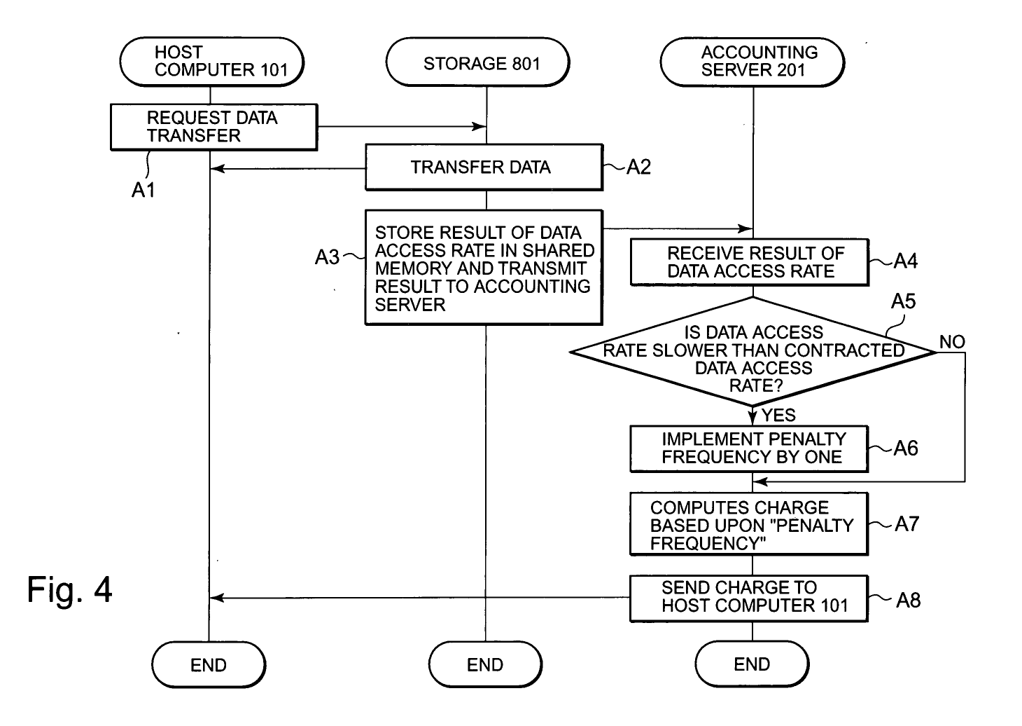

Next, referring to FIG. 4, the operation of the storage accounting system of this exemplary embodiment will be described.

When a user requests host computer 101 to transfer data to storage 801 (step A1), storage 801 starts the transfer of the data requested by host computer 101 in response to the user's request (step A2). When the transfer of the data is completed, I/O process controller 501 writes a data access rate to host computer 101 in the latest transfer of data to an item of “data access rate (Mb/s) 621 for one transfer request from host computer 101” in data access rate table 611. I/O process controller 501 transmits updated data (the latest data access rate to host computer 101) of data held in data access rate table 611 to accounting server 201 (step A3).

When accounting server 201 receives the latest data access rate to host computer 101 (step A4), it compares contracted data access rate 231 of host computer 101 stored in accounting information table 211 and the latest data access rate to host computer 101 (step A5). If the latest data access rate to host computer 101 is not slower (e.g., it is equal to or greater) than contracted data access rate 231, then no implementation to penalty frequency 241 is made (step A5/“NO”).

Conversely, if the latest data access rate to host computer 101 is slower than contracted data access rate 231 (step A6/“YES”), then penalty frequency 241 is incremented by one (step A6). Then, accounting server 201 computes a charge based upon the penalty frequency 241 (step A7), and accounting server 201 sends the charge to the host computer 101 and the receiver 121 of host computer 101 receives the charge (step A8), and the process is finished.

Next, an example of computation of a charge required for the provision of data from storage 801 to host computer 101 . . . 105 will be described.

A charge required for the provision of data from storage 801 may be computed according to an expression (1) as follows.
Charge=Charge A−Charge B+Charge C (1)

In the expression 1, “Charge” means a charge required for data from storage 801. “Charge A” may refer to a charge in case data is provided at a contracted data access rate which a user contracts. The faster a data access rate requested when the user contracts for using storage 801, the higher a charge that will be required for data. “Charge B” may refer to a product acquired by multiplying a unit price of an arbitrary discounted charge for one penalty by penalty frequency 241. Due to “Charge B,” if a data access rate cannot be assured, then the storage service system may compensate the user. “Charge C” may be computed based upon a charge according to a conventional type accounting method such as capacity allocated to each host computer 101 . . . 105, used capacity, etc.

Expression (1) is one example of the charge computing method and various methods of reflecting a data access rate and a penalty in a charge are conceivable. For example, a “Sliding Scale” method may be used as the charge computing method where the slower the data access rate of the host computers 101 . . . 105, the less charge the accounting server 201 computes for the host computer 101 . . . 105.

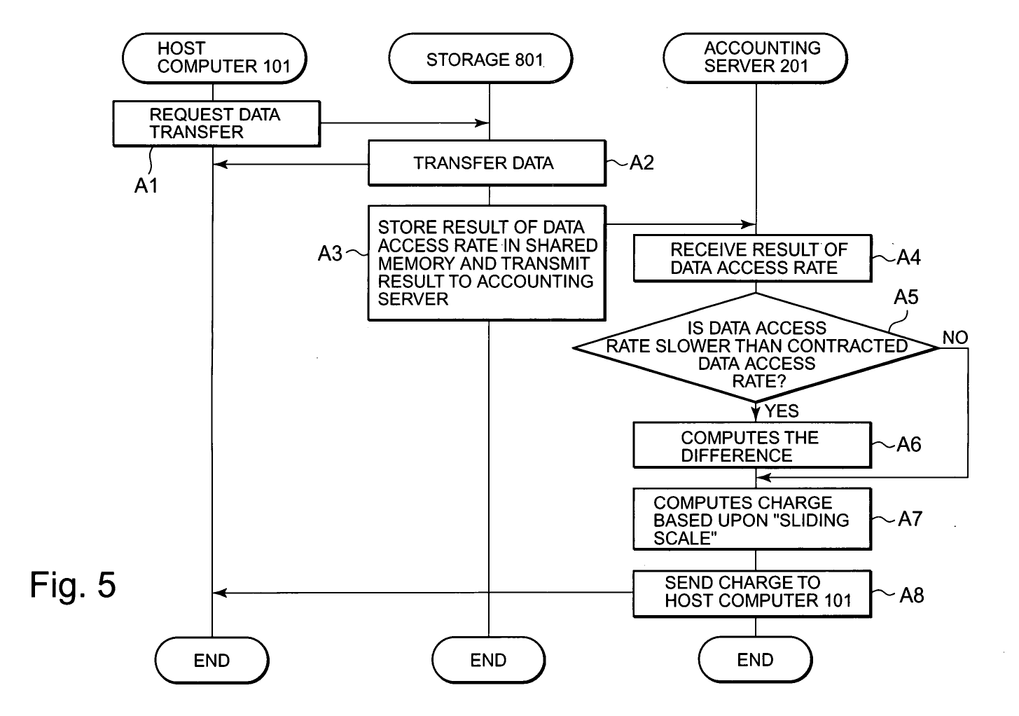

FIG. 5 shows a flowchart showing another exemplary operation of the storage accounting system according to the invention. Other than step A6, step A7, and step A8, the steps are the same as the flowchart in FIG. 4.

In step A6 of FIG. 5, the accounting server 201 computes the difference between the latest data access rate to host computer 101 and contracted data access rate 231. In step A7, the accounting server 201 computes a charge based on a “Sliding Scale” method. The slower the data access rate of the host computers 101, the less charge the accounting server 201 computes for the host computer 101 (step A7). Then, the accounting server 201 sends the charge to the host computer 101 (step A8) and the process is finished.

As described above, according to the exemplary embodiments, the invention enables accounting in consideration of a data access rate by setting a charge according to the data access rate which a user requests, holding a penalty for data access in which the rate requested by the user cannot be provided as the accounting data, and computing a charge based upon these accounting data in the storage system configured so that the data access rate requested by the individual user is met.

While this invention has been described with reference to exemplary embodiments, this description is not intended as limiting. Various modifications of the exemplary embodiments, as well as other embodiments of the invention, will be apparent to persons skilled in the art upon taking the description as a whole. It is, therefore, contemplated that the appended claims will cover any such modifications or embodiments as fall within the true scope of the invention.

Further, the inventor's intent is to encompass all equivalents of all the elements of the claimed invention even if the claims are amended during prosecution.

This application is based on Japanese Patent Application No. 2004-300816 filed on Oct. 14, 2004 and including specification, claims, drawings and summary. The disclosure of the above Japanese Patent Application is incorporated herein by reference in its entirety.

What is claimed is:

1. A storage accounting system, comprising:
a host computer; and
a storage service apparatus that stores data requested by said host computer in accordance with a data access rate of a service agreement, said storage service apparatus monitoring a data access rate of said host computer, and selectively adjusting a parameter of said service agreement based on said monitoring.

2. The storage accounting system, according to claim 1,
wherein when a monitored data access rate of said host computer is slower than said data access rate of said service agreement, said storage service apparatus computes a lesser charge for said host computer.

3. The storage accounting system, according to claim 2,
wherein said storage service apparatus stores a penalty frequency when said monitored data access rate of said host computer is slower than said data access rate of said service agreement, and said storage service apparatus computes said lesser charge based upon said penalty frequency.

4. The storage accounting system, according to claim 2,
wherein the slower said data access rate of said host computer is, the lesser charge said storage service apparatus computes for said host computer.

5. The storage accounting system, according to claim 3, further comprising:
an accounting server that includes a memory that stores said data access rate of said service agreement and said penalty frequency, said accounting server comparing said data access rate of said host computer and said data access rate of said service agreement.

6. The storage accounting system, according to claim 5,
wherein said accounting server updates said penalty frequency when said monitored data access rate of said host computer is slower than said data access rate of said service agreement.

7. The storage accounting system, according to claim 6,
wherein said accounting server sends said charge to said host computer.

8. The storage accounting system, according to claim 7, said storage service apparatus further comprising:
a storage having a physical disk that stores data requested by said host computer;
a storage controller connected to said host computer;
a plurality of channel ports for input and output;
an I/O process controller that monitors said data access rate of said host computer;
a data access rate memory connected to said storage controller that stores said data access rate in said transfer of said data to said host computer; and
an accounting server controller that controls an operation of said accounting server, wherein:
said host computer requests said storage to transfer said data and said storage controller transfers said data from said physical disk to said host computer when said transfer of said data is requested by said host computer;
said storage controller stores said data access rate in said transfer of said data in said data access rate memory when said transfer of said data from said physical disk is completed;
said storage controller transmits said data access rate to said accounting server when said data access rate is stored in said data access rate memory;
said accounting server controller compares said data access rate and said data access rate of said service agreement stored in said memory when said accounting server receives said data access rate;
said accounting server controller updates said penalty frequency when said data access rate is slower than said data access rate of said service agreement;
said accounting server controller computes said charge based upon said penalty frequency; and
said accounting server controller sends said charge to said host computer.

9. A storage accounting system, comprising:
means for using data; and
means for storing data requested by said data using means in accordance with a data access rate of a service agreement, said means for storing data monitoring a data access rate of said data using means, and selectively adjusting a parameter of said service agreement based on said monitored data access rate.

10. A storage service apparatus, comprising:
a storage that stores data requested by a host computer in accordance with a data access rate of a service agreement;
an input/output (I/O) process controller that monitors a data access rate of said host computer; and
an accounting server that selectively adjusts a parameter of said service agreement based on said monitored data access rate.

11. A storage service apparatus, comprising:
means for storing data requested by a host computer in accordance with a data access rate of a service agreement;
means for monitoring a data access rate of said host computer; and
means for selectively adjusting a parameter of said service agreement based on monitored data access rate.

12. A host computer, comprising:
a controller that uses a storage in a storage service apparatus, said controller receives a charge of a service agreement,
wherein said charge is selectively adjusted by said storage service apparatus.

13. A host computer, comprising:
means for using a storage in a storage service apparatus,
means for receiving a charge of a service agreement,
wherein said charge is selectively adjusted by said storage service apparatus.

14. A method of storage service, comprising:
storing data requested by a host computer in accordance with a data access rate of a service agreement;
monitoring a data access rate of said host computer; and
selectively adjusting a parameter of said service agreement based on said monitoring.

15. The method of claim 14, comprising:
computing a lesser charge for said host computer, when said data access rate of said host computer is slower than said data access rate of said service agreement.

16. The method of claim 15, comprising:
storing a penalty frequency at which said data access rate of said host computer is slower than said data access rate of said service agreement; and
computing said lesser charge based upon said penalty frequency.

17. The method of claim 15, wherein:
the slower said data access rate of said host computer, the less charge is computed for said host computer.

18. The method of claim 16, comprising:
comparing said data access rate of said host computer and said data access rate of said service agreement.

19. The method of said storage accounting system, according to claim 18, comprising:
updating said penalty frequency when the monitored data access rate of said host computer is slower than said data access rate of said service agreement.

20. The method of claim 19, comprising:
sending said charge to said host computer.

21. The method of claim 20, further comprising:
providing a storage having a physical disk that stores data requested by said host computer;
connecting a storage controller to said host computer;
providing a plurality of channel ports for input and output, wherein said monitoring is performed by an I/O process controller;
connecting a data access rate memory to said storage controller for storing said data access rate in said transfer of said data to said host computer;
controlling, by an accounting server controller, an operation of said accounting server,
requesting, by said host computer, said storage to transfer said data;
transferring, by said storage controller said data from said physical disk to said host computer when said transfer of said data is requested by said host computer;
storing, by said storage controller, said data access rate in said transfer of said data in said data access rate memory when said transfer of said data from said physical disk is completed;
transmitting, by said storage controller, said data access rate to said accounting server when said data access rate is stored in said data access rate memory;
comparing, by said accounting server controller, said data access rate and said data access rate of said service agreement stored in said memory when said accounting server receives said data access rate;
updating, by said accounting server controller, said penalty frequency when said data access rate is slower than said data access rate of said service agreement;
computing, by said accounting server controller, said charge based upon said penalty frequency; and
sending, by said accounting server controller, said charge to said host computer.

22. The method of claim 14, wherein said storage service comprises a storage accounting.

23. A host computer method, comprising:
using a storage in a storage service apparatus; and
receiving a charge of a service agreement, said charge being selectively adjusted by said storage service apparatus.

24. A signal-bearing medium embodying a program of machine-readable instructions executable by a digital processing apparatus, said program causing a storage service apparatus to perform a method of claim 14.

25. A signal-bearing medium embodying a program of machine-readable instructions executable by a digital processing apparatus, said program causing a host computer to perform a method of claim 23.
